(19) United States
(12) Patent Application Publication
(10) Pub. No.: US 2011/0272551 A1
(43) Pub. Date: Nov. 10, 2011

(54) MOVABLE ASSEMBLY AND APPLICATION TO MOVABLE DEVICES

(76) Inventor: Effrayim Drori, Moshav Geffen (IL)

(21) Appl. No.: 13/138,135

(22) PCT Filed: Jan. 11, 2010
(86) PCT No.: PCT/IL2010/000024

§ 371 Date: Jul. 12, 2011

(30) Foreign Application Priority Data
Jan. 11, 2009 (IL) 196421

(51) Int. Cl. F16H 21/44; F16M 11/00; B23P 11/00

(52) U.S. Cl. 248/324; 29/428; 74/99 R

(57) ABSTRACT

Movable device comprising at least one assembly, said assembly comprising: an equilateral tri-angle, said triangle connected at first vertex to top a fixed reference point by means of a pivot, said pivot is stationary; a stationary pivot, said stationary pivots connects said triangle to said fixed reference point; a pair of arms, wherein first arm is connected at one end to said triangle at second vertex and wherein second arm is connected at one end to said triangle at third vertex, wherein the connection between said arms to the vertices of said triangle is by means of a pivot, said pivot is mobile.

### FIELD OF THE INVENTION

The present invention relates to movable elements. More particularly, the present invention relates to movable elements, where a radial movement of an assembly translates to linear movement of the element and vice versa.

### BACKGROUND

Surfaces that require adjustment or movement of position along either their longitudinal or transverse axis, essentially employ one of several possible mechanisms. Such mechanisms may be, for example, rails extending along parallel edges of the surface, to which the edges of the surface are inserted and may slide through from one fixed position inside the rail to another position. An advanced mechanism of the rails is rails combined with rollers, where the rails extend along the edges of the surface and are equipped with wheels or rollers along or at the ends of the rails. The edges of the surface are then inserted along the rails and atop the wheels that enable their smooth gliding along the rails. Both mechanisms require however halting mechanisms that prevent the surface from slipping outside the rails when reaching their end. Also, rollers and rails mechanisms are generally less robust than simple hinge based mechanisms, and therefore require constant maintenance and repair. A third possible mechanism employs axles, pivots and hinges attached to arms that connect between the movable surface and a fixed reference point or plane, and allow it a certain freedom of movement in accordance with its position relative to the reference point or plane. Various hinge-based mechanisms exist in different applications that require varying degrees of movement of objects within a predetermined range. Hinge-based mechanisms generally prove to combine simplicity and effectiveness, but are still considered to be less user-friendly than rails or rails-roller based mechanisms.

The present invention overcomes the disadvantages of the mechanisms mentioned above with a hinge-based device that provides a simple and effective mechanism that translates radial movement to linear movement on the one hand, and that is user-friendly on the other hand.

Accordingly, the device of the present invention addresses the problems mentioned above by employing a simple mechanism of triangles and arms, which are connected with hinges one to the other, the hinges essentially providing pivot reference points around which the mechanism rotates. As a result of the rotation of the mechanism, an element, attached to the device, responds to simple push/pull action of an operator and moves in linear movement which is limited by the construction of the mechanism itself.

It is therefore an object of the present invention to provide a device for translating radial movement to linear movement.

It is yet another object of the present invention to provide a device that provides both connection and linear movement of an element attached to it.

It is yet another object of the present invention to provide a device that combines simple and effective mechanism of rotation and user-friendly mode of operation in translating the radial movement of the device to linear movement.

It is yet another object of the present invention to provide a device that is composed of an assembly that provides translation of radial movement to linear movement and an element that is attached to it and that responds to simple push/pull actions of an operator by linear movement.

It is yet another object of the present invention to provide a method of constructing a device that provides translation of radial movement to linear movement of an element attached to it and connection to such element.

This and other objects of the invention will become clear as the description proceeds.

### SUMMARY OF THE INVENTION

The present invention provides an assembly for translating radial movement to linear movement by employing a simple mechanism of triangles and arms, connected with hinges one to the other, the hinges essentially providing pivot reference points around which the mechanism rotates. As a result of the rotation of the support mechanism, an element, attached to the assembly, responds to simple push/pull action of an operator and moves in linear movement which is limited by the construction of the rotating mechanism itself.

In one aspect, the present invention provides a device that comprises at least one assembly, where the assembly comprises: an equilateral triangle that is connected at first vertex to a fixed reference point by means of a stationary pivot; a stationary pivot that connects the triangle to the fixed reference point; a pair of arms, where the first arm is connected at one end to the triangle at second vertex and where the second arm is connected at one end to the triangle at third vertex, where the connection between the arms to the vertices of the triangle is by means of a mobile pivot. Optionally, the device further comprises an element attached in horizontal position to anchors and a pair of anchors attached to that element, where the first anchor is located at the right side of the first vertex, and the second anchor is located at the left side of the first vertex. The first anchor is connected to the second end of the first arm and the second anchor is connected to the second end of the second arm, where the connection between the anchors and arms is by means of a mobile pivot.

In one aspect of the present invention, the anchors and mobile pivots are the same or different.

In another embodiment of the present invention, the anchors connect directly to the element.

In still another embodiment, the anchors connect directly to a surface or element.

In one embodiment, the present invention provides a device comprising at least one assembly, where the assembly comprises:

a vertical leg;
an equilateral triangle, that is connected at first vertex to top end of said vertical leg by means of a stationary pivot;
a pair of arms, where the first arm is connected at one end to the triangle at second vertex and where the second arm is connected at one end to the triangle at third vertex, where the connection between the arms to the vertices of the triangle is by means of a mobile pivot. Optionally the device further comprises an element attached in horizontal position to anchors, and a pair of anchors attached to that element, where the first anchor is located at the right side of the first vertex, and the second anchor is located at the left side of the first vertex. The first anchor is connected to the second end of the first arm and the second anchor is connected to the second end of the second arm, where the connection between the anchors and arms is by means of a mobile pivot.

In one embodiment of the present invention is provided a movable device having an element comprising a hollow space at least above the triangle, where the space is of length and width which are sufficient to allow positioning of a portion of the triangle above the element and free rotation of the triangle in the hollow space.

In still another embodiment of the present invention, the anchors in the device with the hollow space are the mobile pivots themselves, and where the anchors are directly connected to the element.

In still another embodiment of the present invention is provided a movable device with an element that is selected from a bar, a plate or a frame.

In still another embodiment of the present invention, the assembly of the device connects directly to a surface or an element.

In still another embodiment of the present invention is provided a movable device in which the leg of the assembly is in the form of a pair of bars positioned parallel one to the other, and form a space between them which is sufficient to enable positioning of the triangle of the assembly and movement of the triangle between the bars.

In still another embodiment of the present invention is provided a movable device where each of the arms of the assembly is in the form of a pair of bars positioned parallel one to the other and connected one to the other at both ends by the same means of connection to the triangle and anchors.

In still another embodiment of the present invention is provided a movable device where each of the arms of the assembly is in the form of a single bar connected to the triangle at one end and to the anchors at the other end.

In still another embodiment of the present invention is provided a movable device where each of the arms is in the form of a canal, which is formed of a bar, and the bar is bent along its longitudinal axis where the longer sides of the bar are brought one toward the other, and a pair of holes at each of the two ends of the bar, wherein the holes in each pair face one another and are suitable for connecting the canal to means of a pivot.

In still another embodiment of the present invention is provided a movable device, where each of the arms is in the form of a fork formed of a bar and a pair of plates at each end of the bar. The plates of each pair are parallel one to the other and perpendicular to the bar, where each plate of each pair comprises a hole that faces the hole in the parallel plate, both holes are suitable for connecting the fork to means of a pivot.

In still another aspect of the present invention is provides a movable device where each of the arms is in the form of a double horseshoe, where the double horseshoe comprises a bar, where the sides of a portion at both ends of the bar are'bent along the longitudinal axis of that portion. One edge of that portion is brought toward the other edge, and each portion comprises a pair of holes that face one another and are suitable for connecting the double horseshoe to means of a pivot.

In still another embodiment of the present invention is provided a movable device, where each of the sides of the triangle is formed of one bar or two bars. The two bars are parallel and spaced one relative to the other and connected one to the other and to the other sides of the triangle. In addition, the bars are of identical dimensions and connected one to the other at their ends with the same connection means that connect the triangle to the leg and to the arms.

In still another embodiment, the present invention provides a movable device where the sides of the triangle are welded one to the other at their ends.

In still another embodiment, the present invention provides a movable device where the triangle is in the form of a single piece. Furthermore, the single piece may be formed by casting.

In another embodiment of the present invention is provided a movable device where the pivots that connect the triangle to the leg, the arms to the triangle and the arms to the anchors are formed of a combination of screws and nuts. Alternatively, the pivots are formed of any other means that provides axis to the components of the assembly that connects them and around which they may rotate. Such means may be any type of pin or wheel that is capable of imparting radial movement.

In one aspect of the present invention is provided a movable device that further comprises means for balancing the movement of the assembly and the direction of movement of the element that is placed on or attached to the assembly.

In one embodiment, the means for balancing the movement of the movable device comprises a rod with screw form end, a cable wrapped around the rod, and a fixed nut located at one side of the rod and connected to the element of the movable device. The rod is screwed to the fixed nut and placed below the element midway between triangles of assemblies and perpendicular to the assemblies, where the cable is connected at both ends to the vertical legs of the assemblies, at positions located above the triangles of the assemblies. The parts of the cable that connect to the legs of the assemblies are parallel to the element of the device. Furthermore, the balancing means as described above may further comprise a mobile nut, which is located at a predetermined position between the screw form end of the rod and the fixed nut and is allowed to travel between that end and the fixed nut. In one embodiment, the fixed nut is connected to said element by welding.

Another embodiment of the present invention provides movable device that comprises at least two assemblies, aligned in column one relative to the other, and further comprising a bar located between the legs of the assemblies and beneath the triangles of the assemblies and connecting the legs one to the other. Such connection strengthens the stability of the device and counter-balances its movement during operation. Furthermore, the device may comprise a second bar located between the legs of the assemblies and connecting the legs at their lower ends and to the ground with fixed bolts, thus fixing the device in place and preventing it from moving sideways during operation.

In one aspect of the present invention, the movable device comprises at least two assemblies, aligned in column one relative to the other, where the left arm of one assembly is connected to the right arm of the consecutive assembly, and where the connection between the arms is by means of a mobile pivot.

In another aspect of the present invention, the movable device comprises at least two assemblies, aligned in column one relative to the other and spaced in a predetermined distance one from the other. Furthermore, the movable device may comprise at least two columns, each column comprising at least two assemblies.

In one embodiment of the present invention the arms of the movable device are equivalent in length one to the other or not equivalent in length one the other.

Furthermore, in one particular embodiment, the arms of the assemblies are equivalent in length one to the other, to the length of the side of the triangle and to the distance between each mobile pivot at the second end of each of the arms and the stationary pivot at the first vertex of the triangle.

In a particular embodiment of the present invention, the triangle, arms, legs, bar and pivots of the movable device are formed of materials selected from metallic materials, synthetic materials or wood product materials. Preferably the metallic materials are iron, steel, nickel, brass, and any combination thereof. The synthetic materials are preferably selected from polycarbonates, olefin polymers, preferably polypropylene, polyethylene and polyvinylchloride, polyurethanes and any combinations or mixtures thereof. In another particular embodiment, the metallic parts of the movable device are galvanized.

In one particular embodiment, the present invention provides a movable device that comprises at least one assembly that comprises: a vertical leg;

an equilateral triangle that is connected at first vertex to top end of the vertical leg by means of a stationary pivot; a pair of arms, where the first arm is connected at one end to the triangle at second vertex and where the second arm is connected at one end to the triangle at third vertex, where the connection between the arms to the vertices of the triangle is by means of a mobile pivot; an element attached in horizontal position to anchors; a pair of anchors attached to the element, where the first anchor is located at right side of the first vertex, and where the second anchor is located at left side of the first vertex. The first anchor is connected to the second end of the first arm and the second anchor is connected to the second end of the second arm, where the connection between the anchors and arms is by means of a mobile pivot, and a plate placed on top of the element of the assembly.

In another particular embodiment of the present invention is provided a movable hanger that comprises a movable device, the device comprises at least one assembly, the assembly comprising: a vertical leg; an equilateral triangle connected at first vertex to top end of the vertical leg by means of a stationary pivot; a pair of arms, where the first arm is connected at one end to the triangle at second vertex and the second arm is connected at one end to the triangle at third vertex, where the connection between the arms to the vertices of said triangle is by means of a mobile pivot; an element attached in horizontal position to anchors; a pair of anchors attached to the element, where the first anchor is located at right side of the first vertex, and where the second anchor is located at left side of the first vertex, where the first anchor is connected to the second end of the first arm and the second anchor is connected to the second end of the second arm, where the connection between the anchors and arms is by means of a mobile pivot; and a lower surface attached to the element of the assembly.

In still another embodiment, the present invention provides a movable hanger that comprises two assemblies connected to a single object in the following configuration: Each of the two assemblies comprises an equilateral triangle connected at first vertex to an anchor connected to the object at one end of the object by means of a stationary pivot; a pair of arms, where the first arm is connected at one end to the triangle at second vertex and the second arm is connected at one end to the triangle at third vertex, where the connection between the arms and the vertices of said triangle is by means of a mobile pivot; a third anchor connected to a fixed wall at the back of the object between the two anchors at the ends of the object, where the third anchor is connected to the second end of the left arm of the assembly that is connected to the anchor at the right end of the object, and to the second end of the right arm of the second assembly that is connected to the anchor at the left end of the object, where the connection between the third anchor and arms is by means of a stationary pivot; where the arms of the assemblies are positioned at parallel planes one relative to the other at a distance that avoids their friction one with the other.

In one particular embodiment, the two assemblies partially overlap.

In still another particular embodiment, the distance between assemblies is not bigger than between half or full thickness of the object.

In another particular embodiment, the object of the above movable hanger is a wing of window.

In still another particular embodiment, the length of the side of the triangle of each assembly is equal to the length of the base of each window after subtracting the combined length of overlap between adjacent windows from the length of the base.

In accordance with the above embodiment, the present invention provides a second option for a movable hanger that comprises two assemblies connected to a single object in the following configuration:

Each of the two assemblies comprises an equilateral triangle connected at first vertex to an anchor connected to the object at one end of the object by means of a stationary pivot; a pair of arms, where the first arm is connected at one end to the triangle at second vertex and the second arm is connected at one end to the triangle at third vertex, where the connection between the arms and the vertices of said triangle is by means of a mobile pivot; where the second end of the left arm of the assembly that is connected to the anchor at the right end of the object is connected to the anchor that is connected to the left end of the object and the first vertex of the triangle of the assembly to its left; where the second end of the right arm of the assembly that is connected to the anchor at the left end of the object is connected to the anchor that is connected to the right end of the object and the first vertex of the triangle of the assembly to its right; where the arms of the assemblies are positioned at parallel planes one relative to the other at a distance that avoids their friction one with the other.

In one particular embodiment, the two assemblies partially overlap.

In one particular embodiment the distance between assemblies is not bigger than between half or full thickness of the object.

In another particular embodiment, the object of the above movable hanger is a wing of a window.

It should be noted that the vertex of each triangle that is not connected to the arms is located along the axis of the stationary anchors that are connected to the back of the fixed wall to which the arms are connected.

In still another particular embodiment, the length of the side of the triangle of each assembly is equal to the length of the base of each window after subtracting the combined length of overlap between adjacent windows from the length of the base.

In still another embodiment of the present invention, a manual or motorized moving mechanism is connected to the rod, which allows easier operation of the device. Particular but not limiting examples of moving mechanisms are a rotational handle connected to the exterior end of the rod, a motor connected to the exterior end of the rod or any transmission mechanism connected separately or in combination of a manual or motorized mechanism to the rod that translates horizontal or radial movement of the operator to radial movement of the rod and linear movement of the assembly.

In still another embodiment of the present invention, a break mechanism is connected to the device, which imparts further control of the movement of the device and ability to halt movement at each specific point on its axis of movement. Such break mechanism may be applied on the rod, thus controlling its rotation. Particular but not limiting examples are a pulley connected to the rod with a transmission system, a split nut, where half the nut is closely tightened to the rod and the second half is controlled by an external mechanism that allows approaching the second half of the nut to the first half of the nut, thereby locking the rod and stopping its radial movement. The movement of the device is thus halted. In one aspect, the present invention provides movable systems that are composed of multiple movable devices, where the application of such compositions are intended to respond to limitations such as limited working area and space and addressing specific requirements of continuous processing of materials and products such as in a production line. Non-limiting examples of production lines, which the systems offered in the present invention may be suitably integrated in, are printing lines, plastic articles production lines or frames production lines. Accordingly, the present invention provides a movable system that comprises two movable devices, where the movable devices are positioned one relative to the other at any angle between 0 degrees and 90 degrees, and where one movable device is positioned above the other movable device and each of the devices comprise two assemblies of the present invention that are aligned in a column one relative to the other and connected one to the other such that the right arm of one assembly is the left arm of the second assembly. Furthermore, such system comprises a frame that supports the movable device that is positioned above the other movable device. In a particular configuration of such movable system, the devices are perpendicular one relative to the other.

In accordance with the above aspect, the present invention provides a multiple movable devices system that comprises two movable devices located one parallel to the other in the following configuration: One movable assembly is attached to one fixed wall and a second movable assembly is attached to a second fixed wall, where the first and second walls are parallel one to the other. Each movable assembly comprises an equilateral triangle and a pair of arms, where each arm is connected at one end to the fixed wall and to one lower vertex of the triangle at the other end. The connection between the top end of the arm and the fixed wall is by means of a stationary pivot. The connection between the lower end of the arm and the lower vertex of the triangle is by means of a mobile pivot. The top vertex of each triangle is connected to the fixed wall by means of pivot, where this pivot is stationary. The distance between each stationary pivot that connects a top end of an arm to the fixed wall and the top stationary pivot of the triangle is equal to half the distance between the stationary pivots that connect the arms to the fixed wall and is equal to the distance between the two lower vertices of the triangle. The two top vertices of the two triangles are connected one to the other by a pole or bar in the longitudinal axis in a way that enables synchronous parallel movement of the two assemblies. Radial movement of the two assemblies translates to radial movement of the pole or bar and enables lifting or movement of any item, object or machinery loaded upon the pole or bar.

In one further embodiment two arms connect each lower vertex of the triangle to each stationary pivot on the fixed wall.

In still another embodiment is provided a second movable devices system as described above positioned between parallel fixed walls in the transverse axis relative to the first movable devices system.

In accordance with the objective of movable systems described above, is provided a movable system that comprises multiple movable devices aligned consecutively one relative to the other, where each movable device comprises at least one assembly as described in the present invention. In one aspect, the present invention provides a kit that comprises the components of at least one assembly of a movable device, where the assembly comprises: an equilateral triangle, a pivot intended to connect the triangle to a fixed reference point and to be stationary, a pair of arms intended to connect the triangle to means of a pivot and to be mobile, a pair of pivots intended to connect the arms to the triangle and to be mobile. Optionally, the kit further comprises a pair of anchors and an element intended to connect to the anchors where the element is in horizontal position relative to the anchors, and a pair of pivots intended to connect the arms to the anchors or the element or directly to a lower or top surface and to be mobile. Optionally, the kit comprises a vertical leg for each assembly, where the leg serves as the fixed reference point for connecting the triangle by means of the stationary pivot.

In still another aspect, the present invention provides a method of constructing a movable device by integrating the components of a kit described above, according to the steps: connecting the triangle to a fixed reference point by means of a stationary pivot; combining the triangle with the arms; combining the arms with the mobile pivots; and combining the mobile pivots with anchors, or the element or the lower or top surface, where when combining the mobile pivots with the anchors then the anchors are combined with the element or the lower or top surface to be connected by welding.

### BRIEF DESCRIPTION OF THE DRAWINGS

FIG. 1A-C is a schematic illustration of a movable device with an assembly connected to a fixed point in a wall.

FIG. 2 is a 3-D schematic illustration of an assembly of the invention in initial position.

FIG. 3 is a 3-D schematic illustration of an assembly of the invention in displaced position.

FIG. 4 is a schematic illustration of a front view of a movable device of the invention with two movable assemblies in initial position.

FIG. 5 is a schematic illustration of a front view of a movable device of the invention with two movable assemblies in displaced position.

FIG. 6 is a schematic illustration of a superposition of initial and displaced positions of the invention.

FIG. 7 is a schematic illustration of a movable device of the invention with two movable assemblies and additional reinforcement bar.

FIG. 8A-D is a schematic illustration of different arms used in the present invention.

FIG. 9A-C is a schematic illustration of hollow elements and assembly attached to hollow element.

FIG. 10A-B is a schematic illustration of assembly with arms even or uneven in length and equal or not to triangle side.

FIG. 11A-C is a schematic illustration of means for balancing the movement of an assembly and an assembly with such means for balancing its movement.

FIG. 12A-B is a schematic illustration of movable hangers connected on top of an object.

### DETAILED DESCRIPTION OF THE DRAWINGS

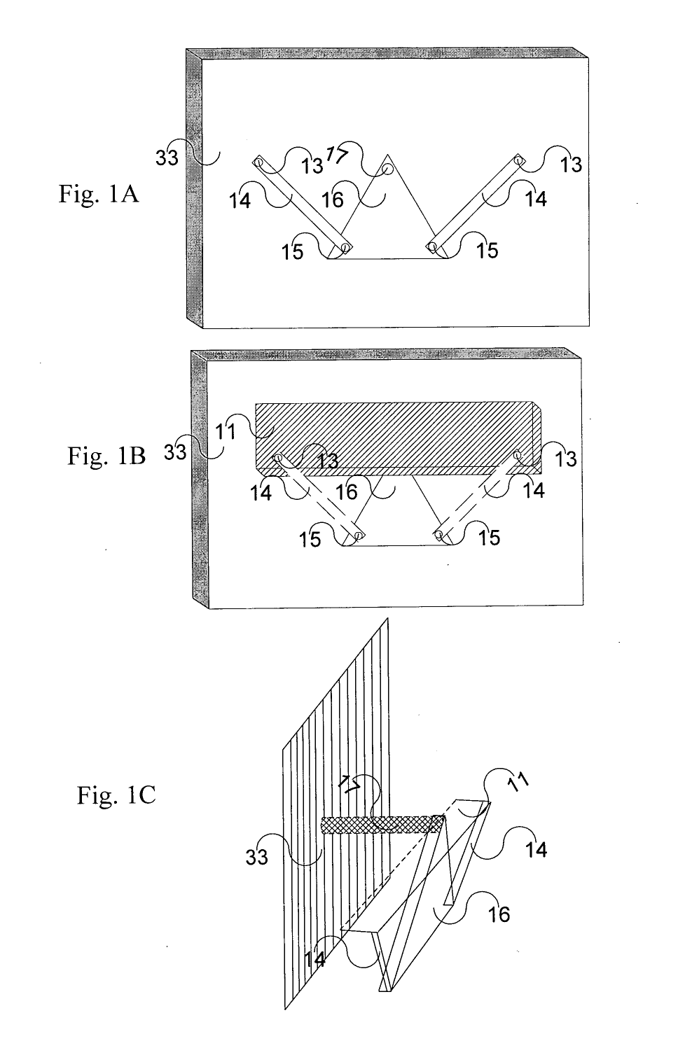

FIG. 1A-C is a schematic illustration of a movable assembly connected to a fixed point of reference (33) by means of a stationary pivot (17). In this general representation of an assembly of the present invention, the assembly is connected directly to a fixed point of reference, such as a wall or any other body by the stationary pivot (17), where this pivot (17) may connect the first vertex of the triangle (16) to the body (33) at any point in the body (33) such that the assembly is located above the ground on which the body stands or is fixed to, and is allowed free rotation around the stationary pivot (17). FIG. 1A is a schematic illustration of a front view of the assembly connected to a body (33). The stationary pivot (17), connected to the triangle (16) at first vertex fixes it to the body (33).

FIG. 1B illustrates a movable device with an assembly connected directly to a fixed point of reference as illustrated in FIG. 1A and related to in the description above. The element (11) is connected to the arms (14) with anchors (not shown) that may be the mobile pivots (13) themselves. The arms (14) connect to the second and third vertices of the triangle (16) with mobile pivots (15). The radial movement of the assembly translates to linear movement of the element (11) and vice versa as the element (11) responds to push/pull actions. In this aspect of the invention, the stationary pivot (17) is designed such that it provides the element (11) free movement without friction with the body (33). FIG. 1C is a schematic illustration of a perspective point of view of a movable device of the present invention. In this particular illustration, the upper portion of the triangle (16) of the assembly protrudes above the element (11) which has a hollow space large enough to accommodate the triangle and allow it free rotation around the axis of the stationary pivot (17). It will be appreciated, however, that the assembly may connect to any type of element, described in the present invention, where the anchors that connect the element to the arms and the mobile pivots themselves or different.

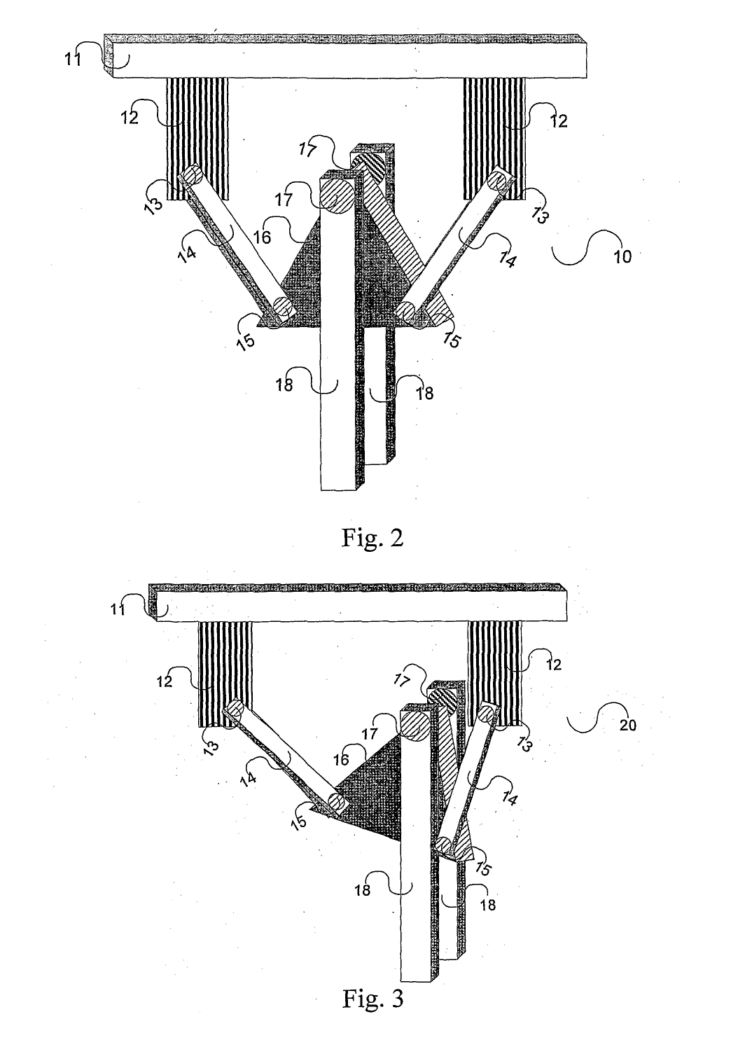

FIG. 2 of the present invention illustrates a three dimensional structure of an assembly (10) of the present invention at initial position. As can be clearly seen, the triangle (16) is placed between two vertical bars (18) that are parallel one to the other and form the vertical leg of the assembly. Generally, but not exclusively, the triangle (16) is connected to the bars of the vertical leg (18) by means of screw and nut that are illustrated by the two circles (17), positioned at one end of the bars (18). The screw is passed through the top vertex of the triangle (16) and locks it to the bars (18), thereby forming a stationary pivot around which the triangle (16) may rotate. The distance between the bars (18) may be any distance that forms a space in which the triangle (16) connected to the arms (14) and pivot (15) is allowed to rotate freely between one initial position and another position to which the triangle (16) is displaced to either left or right direction. The arms (14) of the assembly connect the other two vertices of the triangle to the anchors (12), which are placed to the right and left of a first vertex of the triangle. The connection of the arms to the triangle is by means of a mobile pivot (15), which may be, although not exclusively, a combination of screw and nut, where the screw allows radial movement of the arms which is simultaneous with the radial movement of the triangle. The arms (14) are connected in their other end to anchors (12) by means of a pivot (13). Such pivot may be formed of a combination of screw and nut, although it will be appreciated that any other pivotal means that enables radial movement may be employed in this and all other pivots used in the present invention. The anchors themselves are the mobile pivots (13) that connect to the element (11), thereby rendering the pivot means (13) mobile. The anchors (12) are also placed higher with respect to the leg (18), forming a gap between the leg (18) and the element (11), and as a result also avoiding friction of the element (11) during movement. The arms (14) serve as relay mediators that translate either a linear movement of the element (11) to radial movement of the triangle (16) or a radial movement of the triangle (16) to linear movement of the element (11).

In FIG. 3, the assembly of FIG. 1 (10) is shown in its displaced position (20). Once a linear movement of the element (11) is initiated, then the arms (14) respond simultaneously by making radial movement in the direction of the linear movement of the element (11). The pivotal means (15) enable the radial movement of the arms (14) to be relayed to the triangle (16), which in turn responds by moving radially. Since the arms (14) relaying the movement are connected at their other ends to mobile pivots (13) on the anchors (12), their radial movement is limited to their lengths; so the maximum total distance that the element (11) may travel in one direction equals to the sum of the lengths of the arms. Furthermore, the triangle (16) and the legs (18) may be independently connected to the stationary pivot (17) that is common to both and passes through them rather than been connected one to the other.

It will be appreciated that although the arms (14) in FIG. 3 are shown to be identical in length, they do not necessarily have to be equal to each other, and various combinations of different lengths of the arms (14) are possible within the scope of the present invention. Such combinations may be pre-determinately calculated and applied in order to impart any desired distance of displacement to the element (11). Furthermore, the radial movement of the arms (14) as well as the radial movement of the triangle (16) around the mobile pivots (15) and the stationary pivot (17), respectively, may vary between 0 degrees and 360 degrees. It follows that in certain applications of the present invention, the assembly (10) is capable of making partial or complete radial movement. As a result, the element (11) may be displaced to maximum linear length caused by radial movement of 120 degrees of the triangle (16) and arms (14), and subsequently lift it above its linear plane of movement, and allow it to make radial movement between 0 and 180 degrees.

It will be also appreciated, that various forms of the arms (14) that essentially perform radial movement and relay of such radial movement to linear movement of an element (11), are within the scope of the present invention.

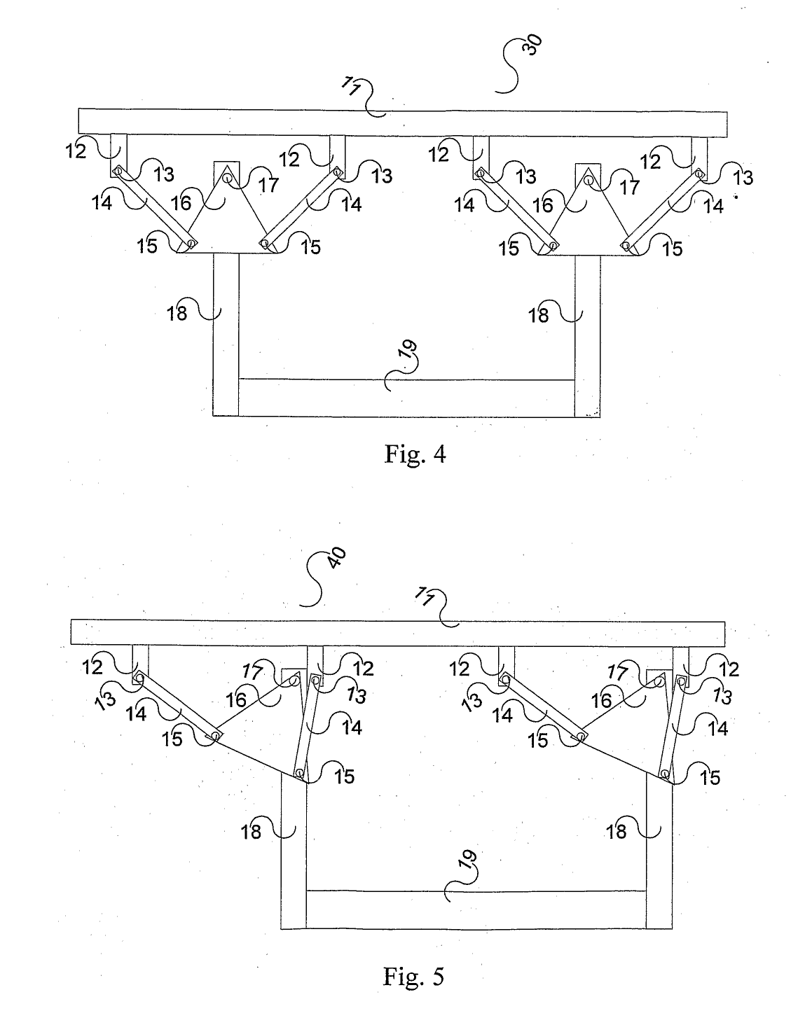

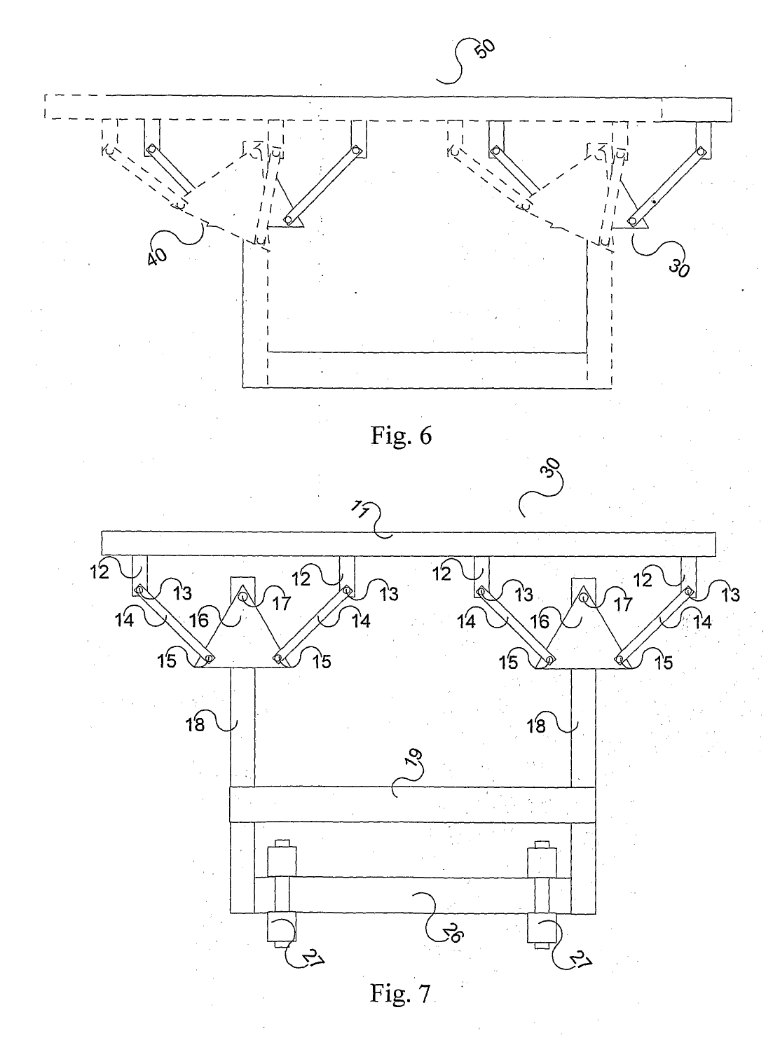

FIG. 4 is a schematic illustration of a front view of a movable device (30) with two assemblies placed one relative to the other in column configuration and connected to a single element (11). The legs (18) of the device (30) are connected one to the other with a lower bar (19) that provides them additional reinforcement and fixes them in place during the radial movement. In this particular embodiment, the assemblies perform radial movement simultaneously and impart linear movement to the element (11). As mentioned above, the assemblies of the device (30) in FIG. 4 may be designed to impart vertical movement to the element (11) above its plane of linear movement and subsequent to its linear movement, which is shown in the following FIG. 5. It will be appreciated that the stationary pivots (17) may be fixed to stationary bodies adjacent to the device, such as a wall or any other stationary point of reference. In this FIG. 5, the device (30) as shown in FIG. 4 is in displaced position (40), where radial movement of the triangles (16) and arms (14) of the assemblies around the stationary pivots (17) and mobile pivots (13, 15) imparts linear movement to the element (11).

FIG. 5 further illustrates the initial and displaced positions of the devices (30, 40) shown in FIGS. 4 and 5, respectively, superimposed (50) one on the other. The superposition (50) of the initial (30) and displaced (40) positions of the device, clearly demonstrates the radial movement of the assemblies of 60 degrees, that imparts displacement of the element in forward linear movement.

Further reinforcement of the device (30) is shown in FIG. 7, where an additional bar (26) lower then the reinforcing bar (19), connects the legs (18) of the two assemblies at their lower ends. Such bar (26) is further reinforced by bolts (27) that connect it to the ground, thereby practically fixing the device (30) to the ground and stabilizing it during radial movement of the triangles (16) and arms (14) and displacement of the element (11).

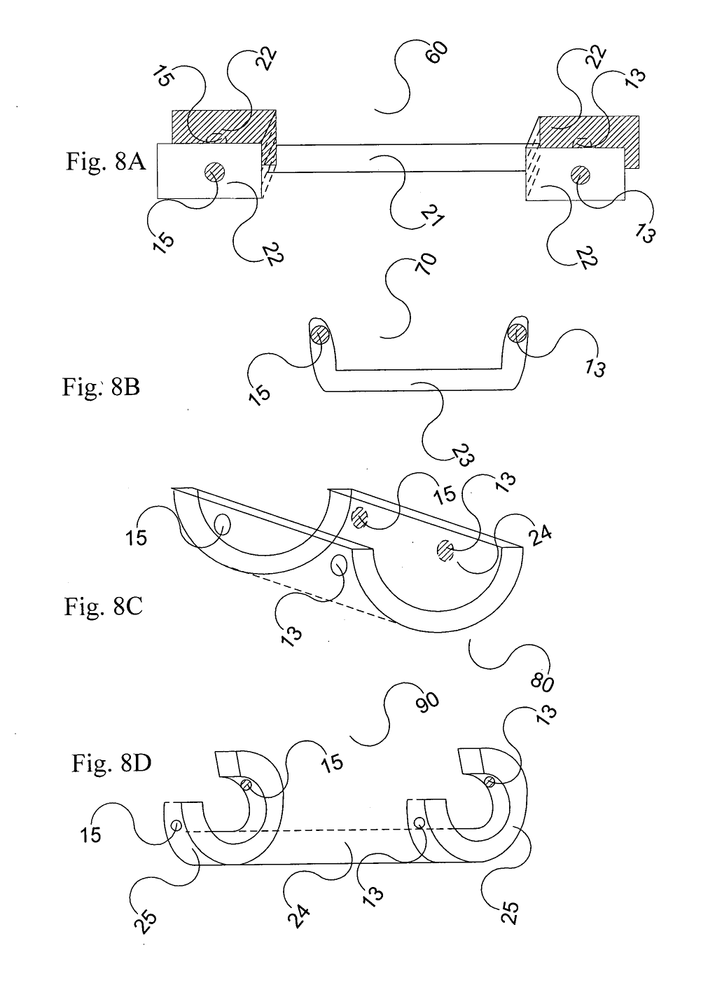

The arms, which were shown in the Figures so far, were shown to be formed of single or double straight bars (14) that connect the second and third vertices of the triangles (16) to the anchors (12) with mobile pivots (13, 15). It will be appreciated, however, that the arms of the assembly of the present invention may take any form or shape that connects between the triangles (16) and the anchors (12) and relay the radial movement of the triangles (16) to linear movement of the element (11). Non-limiting examples of forms of arms that may be employed in the present invention are schematically illustrated in FIG. 8A-D.

In particular, FIG. 8A represents an arm in the form of a double fork shape (60). The length of the arm (21) equals the distance between one vertex of the triangle (16) and the anchor (12). At the fork ends (22), which are perpendicular to the arm's length (21), are placed pivotal means (13, 15) that connect the arm (60) to one vertex of the triangle (16) and to the anchor (12), respectively. The pivotal means may be formed of a combination of screw and nut, where the fork ends (22) embrace one vertex of the triangle (16) in one end and the anchors (12) in the second end. Accordingly, the arm (60) is provided with mobile pivot (15) at its end that is connected to the triangle (16) and mobile pivot (13) at its end that is connected to the anchor (12).

FIG. 8B is another illustration of a type of arm (70) that may be employed in the present invention. The ends of the arm are bent in any degree greater than 0 degrees and up to 90 degrees and connect to the lower vertex of the triangle by means of a mobile pivot (15) and by means of mobile pivot (13) to the anchor.

FIG. 8C is another illustration of a type of arm (80) that may be employed in the present invention. The arm (80) is in the form of a canal with a length (24) that is equal to the distance between one vertex of the triangle (16) and the anchor (12). The width of the canal is such that allows it to embrace one vertex of the triangle (16) and the anchor (12). The ends of the arm (80) connect to the triangle (16) and anchor (12) by means of mobile pivots (13, 15), respectively. Such pivots may be in the form of a combination of screw and nut.

FIG. 8D is another illustration of a type of arm (90) that may be employed in the present invention. The arm (90) is in the form of a double horseshoe that comprises two open rings or ellipses (25) at its ends and a bar or partial canal (24) that connects them one to the other. The distance of the bar or partial canal (24) is equal to the distance between one vertex of the triangle (16) and the anchor (12). The open rings or ellipses (24) embrace the triangle (16) at its lower vertex and the anchor (12), and connect to them by means of mobile pivots (13, 15). Such means may be in the form of a combination of a screw and nut that impart the assembly of the present invention, its radial movement.

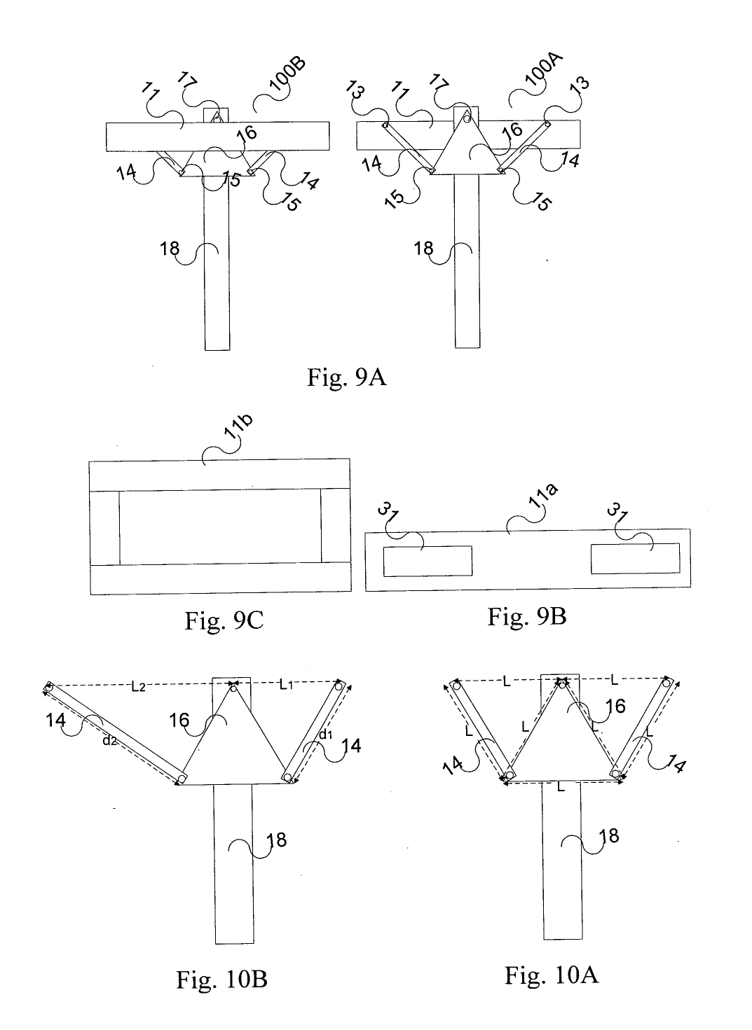

The description of embodiments of the present invention, related so far to a device in which the assemblies are located in a parallel lower or upper surface relative to the surface of the element. However, it will be appreciated within the scope of the present invention that the position of an assembly relative to the element may be such that the upper portion of the triangle protrudes above the surface of the element. FIG. 9A schematically illustrates a front view (100A) and a rear view (100B) of a device, in which the triangle (16) of the assembly protrudes above the surface of the element (11). In this particular illustration, the arms (14) are directly connected to the element (11) where the anchors are the mobile pivots (13) themselves that connect to the element (11). The radial movement of the triangle (16) within the element is enabled due to a hollow opening in the element that provides the triangle (16) with sufficient space for either partial or complete radial movement. FIGS. 9B and 9C illustrate two particular examples of an element that can accommodate a triangle (16) of an assembly of the present invention. FIG. 9B illustrates an element (11) in the form of a bar that comprises two rectangular openings (31) in the bar (11a) capable of accommodating two triangles (16) and enable them sufficient space for radial movement around the stationary pivot (17) that connects between the triangle (16) and the leg (18). FIG. 9C is a schematic illustration of an element (11) in the form of a frame (11b). Here the hollow space inside the frame can accommodate any number of triangles (16) of assemblies and provide them with sufficient space for radial movement.

As has already been mentioned, the length of the arms (14) may be either equal one to the other or not, and FIGS. 10A-B illustrate such cases. FIG. 10A is a schematic illustration of an assembly in which not only the arms are equal in length one to the other but are also equal to the sides of the triangle (16). In addition, the far ends of the arms (14) that are not connected to the vertices of the triangle (16) are fixed a distance from the stationary pivot of the triangle, which is equal to the length of the arms (14) and the sides of the triangle (16). This particular assembly imparts the element the quality of remaining balanced and in horizontal position during linear movement. FIG. 10B represents an assembly in which one arm is longer in length relative to the other arm of the assembly. Such assembly is capable of sustaining an element even when located close to one edge of the element such that the center of gravity of the element is counter-balanced by the assembly. The shorter arm of the assembly will then be attached to one edge or close to the edge of the element, while the longer arm will be attached to a point in the element such that the element will be fixed in horizontal position. In still another particular case, the element may be further held with a fixed device at the second end of the element which is opposite to the location of the assembly.

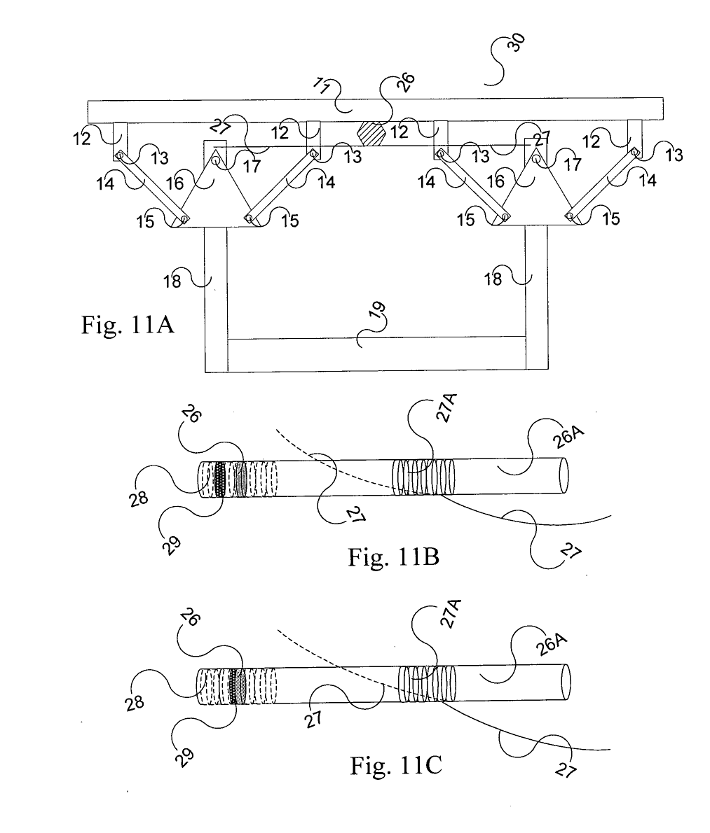

Another option of imparting balance to the element during movement is illustrated in FIG. 11A-C.

FIG. 11A-C is a schematic illustration of means for balancing the movement of an assembly and an assembly with such means for balancing its movement. FIG. 11A illustrates a front view of a movable device (30) balanced by means of a screw rod (26A) (not shown) which is connected to the triangles (16) of two assemblies with a cable (27) in crossed configuration. The rod (26A) is fixed in place by a fixed nut (26) which is connected to the lower side of the element (11). The rod (26A) is screwed to the fixed nut (26) and placed below the element (11) midway between triangles (16) of assemblies and perpendicular to the assemblies, where the cable (27) is connected at both ends to the vertical legs (18) of the assemblies The fixed nut (26) may be connected to the element (11) by welding. FIGS. 11B and 11C illustrate side view of the screw rod (26A), where the near end of the rod is a screw (28) with indentation that matches the thickness of the cable (27). Part of the cable (27A) is wrapped around the rod (26A). When the assembly initiates radial movement, the element (11) moves horizontally, and the rod (26A) responds in radial movement around its longitudinal axis. The cable (27) which is wrapped around (27A) the rod (26A) then releases in motion parallel to the element (11), and the screw form end (28) of the rod (26A) progresses the number of indentations with length equal to the length of cable (27) that was released. A halting mechanism may be further combined to the radial movement of the rod (26A) as illustrated in FIGS. 11B-C. This halting mechanism is formed of a fixed nut (26) and a mobile nut (29). When in initial position as illustrated in FIG. 11B, the mobile nut (29) is located at a predetermined position between the screw form end (28) of the screw rod (26A) and the fixed nut (26) and is allowed to travel between the screw form end (28) of the rod (26A) and the fixed nut (26). During radial movement of the screw rod (26A), the cable (27A) is released and the mobile nut (29) approaches the fixed nut (26) until complete halt is reached. This way the rod (26A) is prevented from complete release and its position is secured.

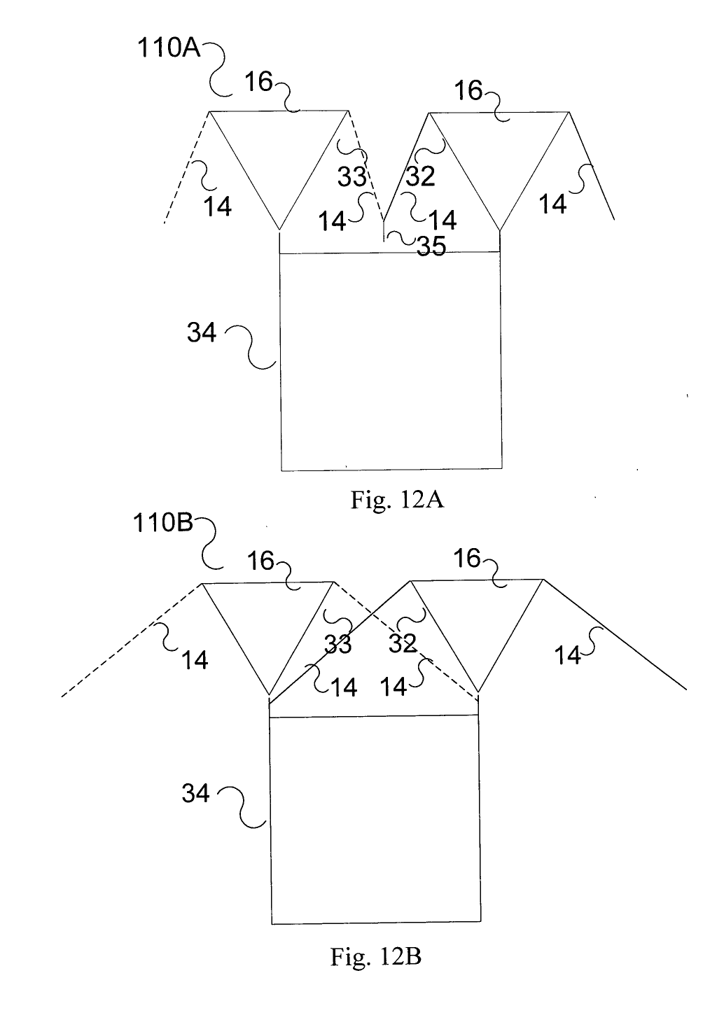

FIG. 12 schematically illustrates another two embodiments of the present invention in front view, where a movable hanger that comprises two assemblies is connected to a single wing (34) of a window in the following configurations:

Embodiment 110A in FIG. 12A illustrates a movable hanger comprising two assemblies that is connected to the upper side of a wing of a window and enables shifting of the window left or right a distance that is equal to the breadth of that window. Each of the two assemblies (32, 33) comprises an equilateral triangle (16) connected at first vertex to an anchor that is connected to the wing (34) at a position near its right and left ends, respectively, by means of a stationary pivot. Each assembly (32, 33) is equipped with a pair of arms (14), where the first arm (14) of each pair is connected at one end to the triangle (16) at second vertex and the second arm is connected at one end to the triangle (16) at third vertex, where the connection between the arms (14) to the vertices of said triangle (16) is by means of a mobile pivot. The particular description of the anchors, vertices and connections between arms and the triangle are consistent with the description of the other figures and will not be repeated here for reasons of conciseness. The left arm of the right assembly (32) and the right arm of the left assembly (33) are connected to an anchor (35) that is connected to a fixed wall at the back of the object between the anchors at the right and left ends of the object. The connection of the left arm of the right assembly and the right arm of the left assembly to anchor (35) is by means of a stationary pivot. The two assemblies are positioned one relative to the other at parallel planes that avoid friction between them upon shifting the wing (34) to the left or right. It should be noted that it is required that only the arms (14) of the two assemblies (32, 33) be in parallel planes. It is not necessary, however, that the triangles (16) of the two assemblies (32, 33) be in parallel different planes. The right arm of the right assembly (32) and the left arm of the left assembly (33) are connected each to the fixed wall at the back of the object by means of a stationary pivot (not shown).

Shifting the wing (34) to the right is enabled as the right assembly (32) performs radial movement, where triangle (16) moves radially, pulling the left arm of the assembly and reducing the distance between the left anti that is connected to anchor (35) and the triangle. The angle between the left arm and the triangle of the right assembly (32) increases as anchor (35) and the left arm connected to it approach the third vertex of the triangle that is connected to the anchor attached to the wing (34). The left assembly (33) responds to the movement of the right assembly (32), and its triangle (16) makes a radial movement to the right as well pulling its left arm and approaching its right arm to anchor (35).

A reflection of the above concerted operation of the two assemblies (32, 33) is applicable to shifting the wing (34) to the left. The configuration in 100A thus allows shifting of a wing (34) a distance that is equal to half the breadth of the wing (34) either right or left, which means back to the original position of the wing (34). It is of course understood that intermediate positions of the wing (34) between the two extreme positions of the wing (34) are also possible.

Embodiment 110B in FIG. 12B illustrates a second configuration of a movable hanger that enables a triple-position wing (34) to shift either left or right within a fixed frame (not shown). In this configuration (110B) the two assemblies (32, 33) are connected to the wing (34) the same way as do the assemblies in embodiment 110A. Namely, the triangle (16) of each assembly (32, 33) is connected to an anchor that is connected to the wing (34) by means of a stationary pivot. However, embodiment 110B does not include a midway anchor, and the left arm (14) of the right assembly (32) is connected to the anchor that is connected to the left side of the wing (34). The right arm (14) of the left assembly (33) is connected to the anchor that is connected to the left side of the wing (34). It is required that only the arms (14) of the two assemblies'(32, 33) be in parallel planes to avoid friction upon shifting the wing (34) to the left or right. It is not necessary, however, that the triangles (16) of the two assemblies (32, 33) be in parallel different planes. The right arm of the right assembly (32) and the left arm of the left assembly (33) are connected each to a fixed wall at the back of the wing (34) by means of a stationary pivot (not shown).

The wing (34) in embodiment 110B is now capable of shifting a distance equal to its breadth either to the right or left. Accordingly, the wing (34) is capable of moving within a fixed frame that is triple in breadth relative to the breadth of the wing (34). As the right assembly (32) performs radial movement, where triangle (16) moves radially, its left arm extends to the right, and the triangle (16) approaches its right arm. The left assembly (33) responds to the movement of the right assembly (32), and its triangle (16) makes a radial movement to the right as well extending its left arm and approaching its right arm that is connected to the anchor of the triangle (16) of the right assembly (32). A reflection of the above concerted operation of the two assemblies (32, 33) is applicable to shifting the wing (34) to the left. The configuration in 100B thus allows shifting of a wing (34) a distance that is equal to the breadth of the wing (34) either right, back to its original position or left to the original position. It is of course understood that intermediate positions of the wing (34) between these three main positions of the wing (34) are also possible.

It is also obvious that wings attached to movable hangers can be positioned one relative to the other in order to cover a frame with matching space. Furthermore, the two assemblies that form the movable hanger can be located either at the top end of the wing or its bottom. In addition, the movable hangers as illustrated and described can be applied to any single or multiple independent units object. In particular, the movable hangers can be applied to multiple wing windows or doors.

Although the present invention has been described with reference to preferred embodiments, workers skilled in the art will recognize that changes may be made in form and detail without departing from the spirit and scope of the invention.

1. Movable device comprising at least one assembly, said assembly comprising:
an equilateral triangle, said triangle connected at first vertex to top a fixed reference point by means of a pivot, said pivot is stationary;
a stationary pivot, said stationary pivots connects said triangle to said fixed reference point;
a pair of arms, wherein first arm is connected at one end to said triangle at second vertex and wherein second arm is connected at one end to said triangle at third vertex, wherein the connection between said arms to the vertices of said triangle is by means of a pivot, said pivot is mobile; optionally,
an element attached in horizontal position to anchors; and optionally a pair of anchors attached to said element, wherein first anchor is located at right side of said first vertex, and wherein second anchor is located at left side of said first vertex, said first anchor is connected to second end of said first arm and said second anchor is connected to second end of said second arm, wherein the connection between the anchors and arms is by means of a pivot, said pivot is mobile.

2. Movable device according to claim 1, wherein said assembly further comprises a vertical leg, said vertical leg is connected to said triangle at first vertex to top end of said vertical leg by means of a stationary pivot.

3. Movable device according to claim 1, wherein the anchors are the mobile pivots.

4. Movable device according to claim 3, wherein said anchors connect directly to the element.

5. Movable device according to claim 1, wherein said element is hollow at least above said triangle in length and width sufficient to allow positioning of a portion of said triangle above said element and free rotation of the triangle in the hollow space.

6. Movable device according to claim 3, wherein the anchors are the mobile pivots, said mobile pivots connect directly to the element.

7. Movable device according to claim 1-6, wherein said element is selected from bar, plate, frame or any other element.

8. Movable device according to claim 1, wherein the pivots may be any type of means capable of imparting radial movement, preferably said means are a pin or wheel.

9. Movable device according to claim 1, wherein each of the arms of the assembly is in the form of a single bar connected to the triangle at end and to the anchors at the other end.

10. Movable device according to claim 1, wherein said leg is in the form of a pair of bars positioned parallel one to the other, said bars form a space between them sufficient to enable positioning of said triangle and movement of said triangle between said bars.

11. Movable device according to claim 1, wherein each of the arms is in the form of a pair of bars positioned parallel one to the other, said bars are connected one to the other at both ends by same means of connection to said triangle and said anchors.

12. Movable device according to claim 1, wherein each of said arms is in the form of a canal, said canal is formed of a bar, said bar is bent along its longitudinal axis where the longer sides of said bar are brought one toward the other, and a pair of holes at the two ends of said bar, wherein the holes in each pair face one the other and are suitable for connecting said canal to means of a pivot.

13. Movable device according to claim 1, wherein each of said arms is in the form of a fork, said fork is formed of a bar and a pair of plates at each end of said bar, said plates of each pair are parallel one to the other and perpendicular to said bar, wherein each plate of each pair comprises a hole, the holes at each pair face one the other and are suitable for connecting said fork to means of a pivot.

14. Movable device according to claim 1, wherein each of said arms is in the form of a double horseshoe, said double horseshoe comprises a bar, wherein the sides of a portion at both ends of said bar are bent along the longitudinal axis of said portion, where one edge of said portion is brought toward the other edge, wherein each portion comprises a pair of holes, said holes face one the other and are suitable for connecting said double horseshoe to means of a pivot.

15. Movable device according to claim 1, wherein each of the sides of said triangle is formed of one bar or two bars, said two bars are parallel and spaced one relative to the other and connected one to the other and to the other sides of said triangle, said bars are of identical dimensions and connected one to the other at their ends with same connection means that connect said triangle to said leg and to said arms.

16. Movable device according to claim 1, wherein the sides of said triangle are welded one to the other at their ends.

17. Movable device according to claim 1, wherein said triangle is in the form of a single piece.

18. Movable device according to claim 17, wherein said single piece is formed by casting.

19. Movable device according to claim 1, wherein the pivots that connect said triangle to said leg, said arms to said triangle and said arms to said anchors are formed of a combination of screws and nuts.

20. Movable device according to claim 1, further comprising means for balancing the movement of said assembly and the direction of movement of said element that is placed on or attached to said assembly.

21. Movable device according to claim 20, wherein said means comprises a rod with screw end form, a cable wrapped around said rod, and a fixed nut located at one side of said rod and connected to the lower side of the element midway between triangles of assemblies of said device, said rod is screwed to the fixed nut and is perpendicular to said assemblies, said cable is connected at both ends to the legs of the said assemblies and parallel to said element.

22. Movable device according to claim 21, wherein said fixed nut is connected to said element by welding.

23. Movable device according to claim 21, wherein said means further comprising a mobile nut, said mobile nut located at a predetermined position between the screw form end of the rod and the fixed nut and is allowed to travel between said end and said fixed nut.

24. Movable device according to claim 1, comprising at least two assemblies, said assemblies are aligned in column one relative to the other, and further comprising a bar located between the legs of said assemblies and beneath the triangles of said assemblies and connecting said legs one to the other.

25. Movable device according to claim 24, further comprising a second bar located between the legs of said assemblies and connecting said legs at their lower ends.

26. Movable device according to claim 1, comprising at least two assemblies, said assemblies are aligned in column one relative to the other, wherein the left arm of one assembly is connected to the right arm of the consecutive assembly, wherein the connection between the arms is by means of a pivot, said pivot mobile.

27. Movable device according to claim 1, comprising at least two assemblies, said assemblies are aligned in column one relative to the other and are spaced in a predetermined distance one from the other.

28. Movable device according to any one of claim 26 or 27, comprising at least two columns comprising at least two assemblies.

29. Movable device according to claim 1, wherein said arms are equivalent in length one to the other or not equivalent in length one the other.

30. Movable device according to claim 29, comprising at least two assemblies, wherein the arms of said assemblies are equivalent in length one to the other and to the length of the side of said triangle and wherein the distance between each mobile pivot at the second end of each of said arms and the stationary pivot at the first vertex of said triangle is equal to the length of one arm.

31. Movable device according to any of the preceding claims, wherein said triangle, arms, legs, bar and pivots are formed of materials selected from metallic materials, synthetic materials or wood product materials, preferably said metallic materials are iron, steel, nickel, brass, and any combination thereof, said synthetic materials are polycarbonates, olefin polymers, preferably polypropylene, polyethylene and polyvinylchloride, polyurethanes and any combinations or mixtures thereof.

32. Movable device according to claim 31, wherein the metallic parts of said device are galvanized.

33. Movable support device comprising at least one assembly, said assembly comprising:
a vertical leg;
an equilateral triangle, said triangle connected at first vertex to top end of said vertical leg by means of a pivot, said pivot is stationary;
a pair of arms, wherein first arm is connected at one end to said triangle at second vertex and wherein second arm is connected at one end to said triangle at third vertex, wherein the connection between said arms to the vertices of said triangle is by means of a pivot, said pivot is mobile; an element attached in horizontal position to anchors; a pair of anchors attached to said element, wherein first anchor is located at right side of said first vertex, and wherein second anchor is located at left side of said first vertex, said first anchor is connected to second end of said first arm and said second anchor is connected to second end of said second arm, wherein the connection between the anchors and arms is by means of a pivot, said pivot is mobile and,
a plate placed on said element of said assembly.

34. Movable hanger device comprising movable device comprising at least one assembly, said assembly comprising:
a vertical leg;
an equilateral triangle, said triangle connected at first vertex to top end of said vertical leg by means of a pivot, said pivot is stationary;
a pair of arms, wherein first arm is connected at one end to said triangle at second vertex and wherein second arm is connected at one end to said triangle at third vertex, wherein the connection between said arms to the vertices of said triangle is by means of a pivot, said pivot is mobile; an element attached in horizontal position to anchors; a pair of anchors attached to said element, wherein first anchor is located at right side of said first vertex, and wherein second anchor is located at left side of said first vertex, said first anchor is connected to second end of said first arm and said second anchor is connected to second end of said second arm, wherein the connection between the anchors and arms is by means of a pivot, said pivot is mobile, and
a lower surface attached to said element of said assembly.

35. Movable system comprising:
two movable devices, wherein said movable devices are positioned one relative to the other at any angle between 0 degrees and 90 degrees and wherein one movable device is positioned above the other movable device, each of said devices comprises two assemblies, each assembly is as claimed in claim 1, wherein the assemblies in each device are aligned in a column one relative to the other and connected one to the other such that the right arm of one assembly is the left arm of the second assembly; and
a frame supporting the movable device that is positioned above the other movable device.

36. Movable system according to claim 34, wherein said movable devices are perpendicular one relative to the other.

37. Movable system comprising multiple movable devices, said movable devices aligned consecutively one relative to the other, each movable device comprises at least one assembly, said assembly is as claimed in claim 1.

38. Movable hanger comprising two assemblies, said assemblies are connected to a single object in the following configuration: each of the two assemblies comprises an equilateral triangle connected at first vertex to an anchor connected to said object at one end of the object by means of a stationary pivot; a pair of arms, where the first arm is connected at one end to said triangle at second vertex and the second arm is connected at one end to the triangle at third vertex, where the connection between said arms and the vertices of said triangle is by means of a mobile pivot; a third anchor connected to fixed wall at the back of said object between the two anchors at the ends of the object, where said third anchor is connected to the second end of the left arm of the assembly that is connected to the anchor at the right end of said object, and to the second end of the right arm of the second assembly that is connected to the anchor at the left end of said object, where the connection between the third anchors and arms is by means of a stationary pivot; where the arms of the assemblies are positioned at parallel planes one relative to the other at a distance that avoids their friction one with the other.

39. Movable hanger that comprising two assemblies connected to a single object in the following configuration: each of the two assemblies comprises an equilateral triangle connected at first vertex to an anchor connected to said object at one end of said object by means of a stationary pivot; a pair of arms, where the first arm is connected at one end to said triangle at second vertex and the second arm is connected at one end to said triangle at third vertex, where the connection between the arms and the vertices of said triangle is by means of a mobile pivot; where the second end of the left arm of the assembly that is connected to the anchor at the right end of said object is connected to the anchor that is connected to the left end of said object and the first vertex of the triangle of the assembly to its left; where the second end of the right arm of the assembly that is connected to the anchor at the left end of said object is connected to the anchor that is connected to the right end of said object and the first vertex of the triangle of the assembly to its right; where the arms of said assemblies are positioned at parallel planes one relative to the other at a distance that avoids their friction one with the other.

40. Movable hanger according to claim 38 or 39, wherein the distance between said assemblies is not bigger than between half or full thickness of the object.

41. Movable hanger according to claim 38 or 39, wherein said object of the above movable hanger is a wing of window.

42. Movable hanger according to claim 38 or 39, wherein the length of the side of the triangle of each assembly is equal to the length of the base of each wing after subtracting the combined length of overlap between adjacent wings from the length of the base.

43. A kit comprising at least one assembly of movable device, said assembly comprising:
an equilateral triangle;
a pivot intended for connecting said triangle to a fixed point of reference and to be stationary;
a pair of arms intended to connect said triangle to means of a pivot, said means are intended to be mobile;
a pair of pivots intended to connect said arms to said triangle and to be mobile;
a pair or pivots intended to connect said arms to said anchors or directly to said element or a lower or top surface and to be mobile; optionally
a pair of anchors; and optionally
an element intended to connect to said anchors when said element is in horizontal position relative to said anchors.

44. A method of constructing movable device, said method comprising integrating the components of a kit according to claim 38 according to the steps of:
combining said triangle with said stationary pivot;
combining said stationary pivot with said fixed point of reference;
combining said triangle with said arms;
combining said arms with pivots said pivots are mobile; and
combining the mobile pivots to anchors, or to the element or to the lower or top surface, wherein when combining said mobile pivots with said anchors then said anchors are combined with said element or said lower or top surface to be connected by welding.

45. A method of constructing movable device, said method comprising integrating the components of a kit according to claim 38 according to the steps of:
combining said triangle with said vertical leg by means of a pivot, said pivot is stationary;
combining said triangle with said arms;
combining said arms with pivots, said pivots are mobile; and
combining the mobile pivots to anchors, or to the element or to the lower or top surface, wherein when combining said mobile pivots with said anchors then said anchors are combined with said element or said lower or top surface to be connected by welding.

46. Movable device, according to any one of claims 1-34, substantially as herein described with reference to the drawings.

47. Movable system according to any one of claims 35-37, substantially as herein described with reference to the drawings.

48. Movable hanger, according to any one of claims 38-42, substantially as herein described with reference to the drawings.

49. A kit according to claim 43, substantially as herein described and exemplified.

50. A method according to any one of claims 44-45, substantially as herein described and exemplified.
